(19) United States
(12) Patent Application Publication
(10) Pub. No.: US 2008/0110483 A1
(43) Pub. Date: May 15, 2008

(54) MOBILE SYSTEM FOR AMPUTEES

(76) Inventors: Judith A. Herba, Dearborn, MI (US); John Bryant, Macomb, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/936,308

(22) Filed: Nov. 7, 2007

Related U.S. Application Data
(60) Provisional application No. 60/864,995, filed on Nov. 9, 2006.

(51) Int. Cl. A61H 3/00

(52) U.S. Cl. 135/67

(57) ABSTRACT

A support unit for supporting a user's leg upon a walker includes a support body which is configured to engage and retain a portion of a user's leg and an attachment system for affixing the support body to a walker.

### CROSS-REFERENCE TO RELATED APPLICATIONS

This patent application claims priority of Provisional Patent Application Ser. No. 60/864,995 filed Nov. 9, 2006, for “Mobile Amputee Hammock.”

### FIELD OF TEE INVENTION

This invention relates generally to support devices for persons having compromised mobility. More specifically, the invention relates to a support device for engaging a portion of a user's leg and supporting some portion of that user's weight upon a conventional walker.

### BACKGROUND OF THE INVENTION

There are a large number of persons who have had a lea amputated as a result of traumatic injury or disease. Such persons generally utilize a prosthetic leg to accommodate day-to-day mobility. However, due to issues of nerve sensitivity, pressure sores, other irritation factors or convenience, the prosthesis is rarely worn during the entire day, and in virtually all instances is removed during the nighttime for sleeping. An amputee's mobility is considerably reduced when the prosthesis is removed. And, owing to the time required for reaffixing the prosthesis, amputees will frequently move about by hopping on one leg when temporary mobility is required and the prosthesis is not affixed. In addition to being precarious and difficult, such hopping mobility can cause harm to the intact leg as a result of impact loading.

Accordingly, there is a need for a safe, reliable, and easy to use system which can provide temporary mobility to an amputee. In addition to benefiting amputees, such systems could also be of utility to persons having the function of a leg otherwise compromised, as for example by injury, paralysis, surgical restrictions or the like.

As will be explained in detail hereinbelow, the present invention provides a system which is usable in conjunction with a conventional walker, and which operates to provide a support which engages a portion of a user's leg so as to support some of the user's weight upon the walker. The system may be used as a substitute for a prosthetic leg. These and other advantages of the invention will be apparent from the drawings, discussion and description which follow.

### BRIEF DESCRIPTION OF THE INVENTION

Disclosed herein is a support unit for supporting a user's leg upon a walker. The support unit includes a support body which is configured to engage and retain a portion of the user's leg, and an attachment system for affixing the support body to a frame of a walker. When the support body is attached to the walker and the user's leg is placed in the support body, a portion of the user's weight is supported by the frame of the walker. The support body may comprise a flexible sheet of material or it may comprise a rigid body configured to define a cavity which receives a portion of the user's leg. The attachment system may comprise a plurality of hooks and/or one or more lines. In some instances, the attachment system may comprise a rigid, integral portion of the support body.

### BRIEF DESCRIPTION OF THE DRAWINGS

FIG. 1 is a perspective view of a walker having one embodiment of support unit of the present invention affixed thereto;

FIG. 2 is a side elevation view of the embodiment of FIG. 1;

FIG. 3 is a front elevation view of the embodiment of FIG. 1;

FIG. 4 is a top plan view of a portion of one support unit of the present invention;

FIG. 5 is a top plan view of another embodiment of support unit of the present invention;

FIG. 6 is a front elevation view of the support unit of FIG. 4 as affixed to a walker;

FIG. 7 is a front elevation view of the support unit of FIG. 5 as affixed to a walker;

FIG. 8 is a perspective view of a walker showing another embodiment of support unit of the present invention affixed thereto;

FIG. 9 is a perspective view of a walker showing another embodiment of support unit of the present invention affixed thereto;

FIG. 10 is a perspective view showing one embodiment of the present invention in use; and

FIG. 11 is a perspective view of another embodiment of a support unit of the present invention as affixed to a walker.

### DETAILED DESCRIPTION OF TEE INVENTION

The present invention comprises a support unit for supporting a user's lea upon a walker. As such, the system may be used to support a portion of a leg having an amputation, in which instance the system can substitute for a prosthetic leg. In other instances, the system can support a portion of an intact leg and provide mobility to a person having compromised function of that leg. The system provides convenient, comfortable and safe mobility to persons having compromised leg function. The system is easy to use and low in cost and by its configuration can accommodate a broad range of users. The system includes a support body which is configured to engage and retain a portion of the user's leg, and an attachment system for affixing the support body to the frame of a conventional walker. As such, the system may be adapted to walkers of various configuration and design, and may be affixed to and removed from the walker as suits a user's needs. The system may be implemented in a variety of configurations, and some particular configurations are shown herein.

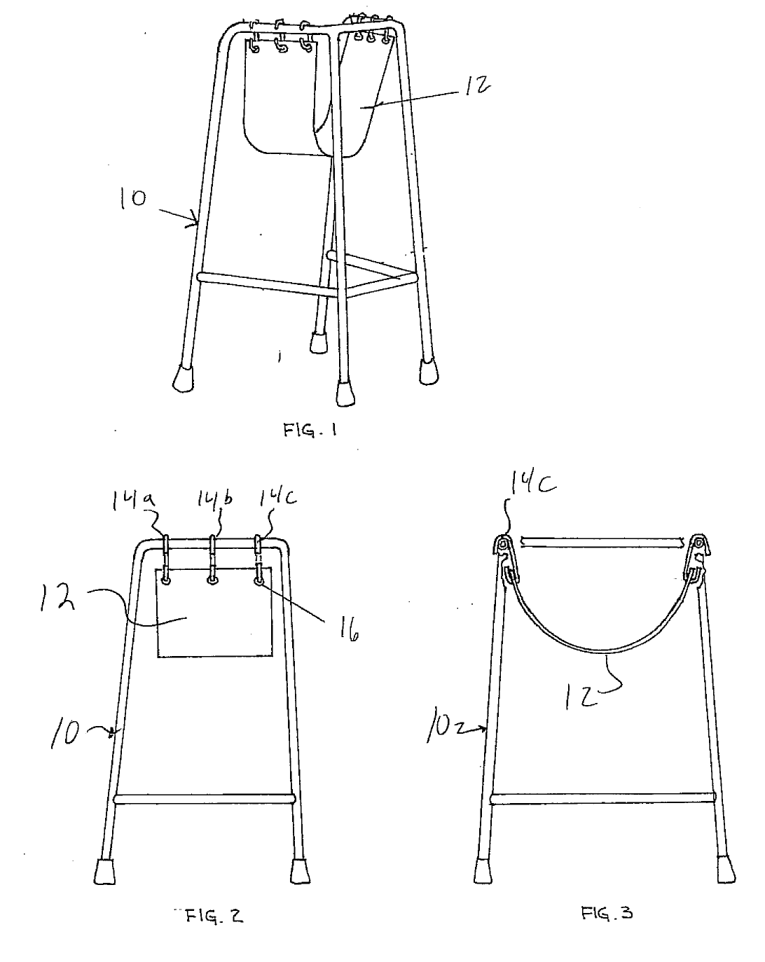

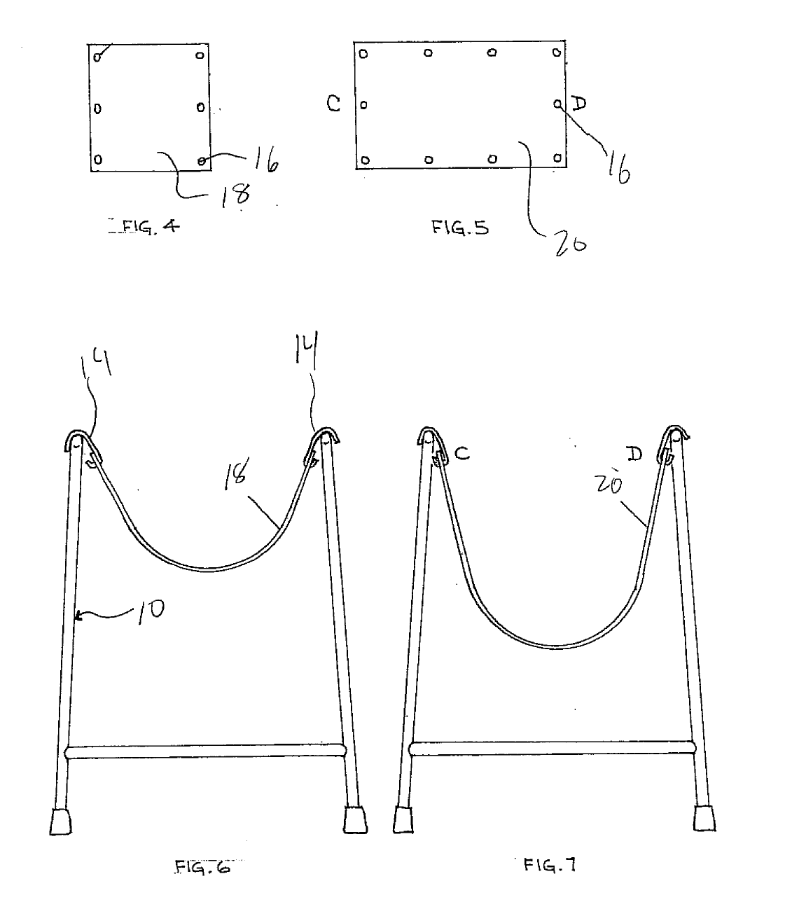

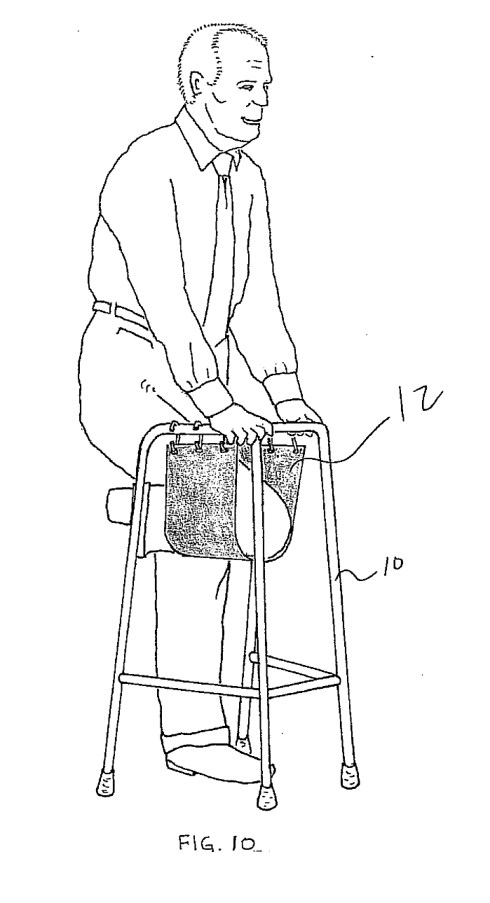

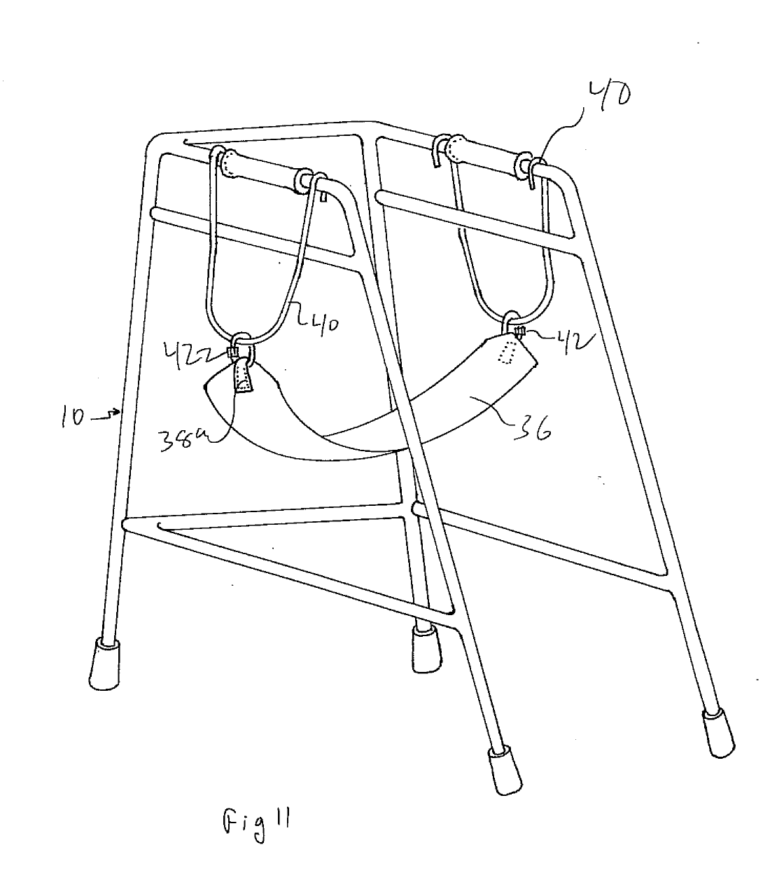

Referring now to FIG. 1, there is shown a walker 10 having one embodiment of support body 12 affixed thereto. FIG. 10 is a perspective view of the support unit of FIG. 1 showing its use. As will be seen, a user having a lower limb amputation has supported the knee portion of his leg in the support body 12. As a consequence, some portion of his body weight is borne by the walker 10 thus enabling the user to stand and walk about.

FIG. 2 is a side elevation view of the walker 10 and support body 12 of FIG. 1. In this embodiment, the support body 12 is formed from a flexible sheet material, and as such may comprise a fabric, a polymeric material, a natural material such as leather or tile like, or it may comprise a composite. The support body 12 is affixed to the frame of the walker 10 by a series of hooks 14a-c each of which passes through a grommet, for example grommet 16 in the support body 12. In the illustration, the hooks 14 are shown as being S hooks; however, other hook configurations may be used such as C hooks, J hooks, or the like. Likewise, clamps, toggles, shackles and other such hardware may be used to affix the support body. In some instances, the support body may be affixed by means of separable hook-and-loop fasteners, lines, cords, or the like. The attachment may be via grommets, eyelets or the like as are associated with the support body. In some instances, the attachment may be via an integral portion of the support body. FIG. 3 is a front elevational view of the walker and support body of FIGS. 1 and 2.

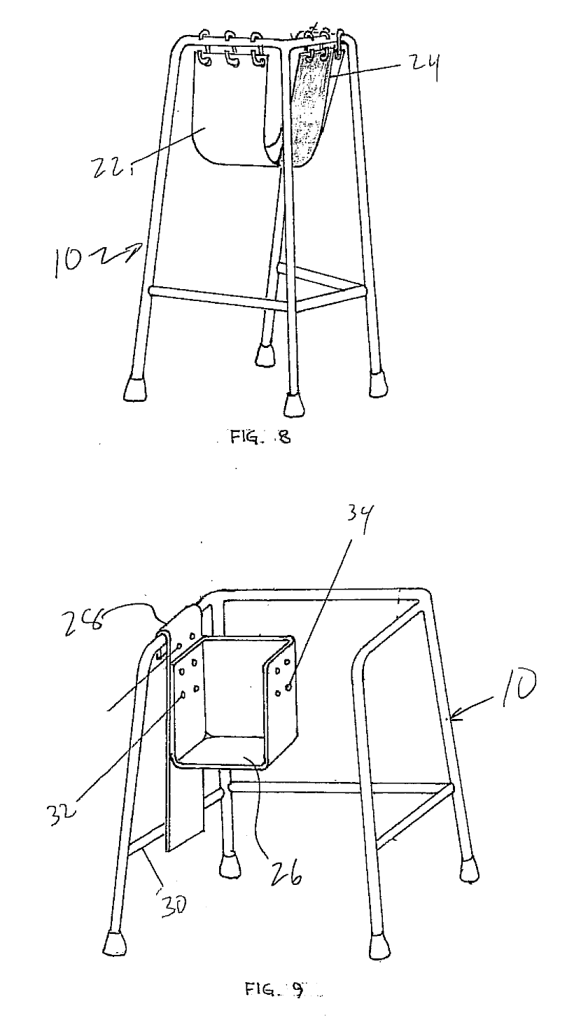

FIG. 4 shows a top plan view of one embodiment of support body 18 configured as a square member. As will be seen, the support body 18 includes a plurality of grommets 16 therein. FIG. 6 is a front elevational view of a walker 10 having the support body 18 affixed thereto by a plurality of hooks 14. FIG. 5 is a top plan view of another embodiment of support body 20 in accord with the present invention. This support body 20 is of a generally rectangular shape. It includes grommets 16 along both the short and long edges thereof. When this embodiment is supported on a walker 10, as is shown in FIG. 7, via the grommets 16 on the short edges, the support body 20 will form a relatively long loop or trough as is seen in FIG. 7. Alternatively, this member may be supported via the grommets along the short edges and will thus form a shallower trough similar to that of the embodiment of FIG. 6. In this manner, the system may be adjustable to accommodate various users.

Yet other embodiments of support body may be implemented. For example, FIG. 8 shows a perspective view of a walker 10 having a three lobed support body 22 affixed thereto. In this regard, the support body 22 is generally similar to the rectangular body of FIGS. 5 and 7 except that it includes a projecting third lobe 24.

FIG. 9 shows yet another embodiment of support system. As illustrated therein, a walker 10 has a support body 26 affixed thereto. The support body 26 is a rigid body which defines a cavity which is configured to receive a portion of a user's leg. The support body 26 may be configured from a rigid, molded polymeric material, from a metal, or from any other such relatively rigid material. The support body 26 is affixed to the walker by a hook 28 configured to have an extension portion which engages a lower rung 30 of the walker. As shown in this embodiment, the support body 26 is affixed to the hook 28 via a series of pegs 32 which project from the hook 28. As illustrated, the support body includes a second set of holes 34 which are configured to engage the pegs 32 so that the position of the support body 26 may be reversed with regard to the walker 10.

FIG. 11 shows yet another embodiment of support unit as affixed to a walker 10. The FIG. 11 embodiment includes a support body 36 configured as a hammock or sling having sewn-in loops such as loop 38a which are used to affix the support body 36 to the frame of the walker 10 via hooks 40. In this embodiment, the hooks 40 are affixed to the loops 38 via screw closeable links 42; although, it is to be understood that other affixation devices may be used, and in some instances, the hook 40 may simply be threaded through the loop 38 thereby dispensing with the need for the intermediate connectors.

In view of the teaching presented herein, yet other modifications, variations and embodiments of the invention may be implemented by one of skill in the art. The foregoing drawings, discussion and description are illustrative of particular embodiments of the invention, but are not meant to be limitations upon the practice thereof. It is the following claims, including all equivalents, which define the scope of the invention.

1. A support unit for supporting a user's leg upon a walker, said support unit comprising:
a support body which is configured to engage and retain a portion of the user's leg; and
an attachment system for affixing the support body to a frame of the walker, whereby when the support body is attached to the walker and the user's leg is placed in the support body, a portion of the user's weight is supported by the frame of the walker.

2. The support unit of claim 1 wherein the support body comprises a flexible sheet of material.

3. The support unit of claim 2 wherein the flexible sheet of material is fabric.

4. The support unit of claim 2 wherein the attachment system comprises a plurality of hooks, each of said hooks being configured to engage the frame of the walker and the support body.

5. The support unit of claim 1 wherein the support body comprises a rigid body of material configured to define a cavity configuration to retrieve the portion of the user's leg.

6. The support unit of claim 5 wherein the attachment system comprises a rigid panel configured to engage the frame of the walker and the support body, whereby at least a portion of the rigid panel is attached to the support body.

7. A walker assembly, comprising:
a walker for assisting a user's movement; and
a support unit comprising: a support body which is configured to engage and retain a portion of a user's leg and an attachment system for affixing the support body to a frame of the walker, whereby when the support body is attached to the walker and the user's leg is placed in the support body, a portion of the user's weight is supported by the frame of the walker.

8. The support unit of claim 7 wherein the support body comprises a flexible sheet of material.

9. The support unit of claim 8 wherein the attachment system comprises a plurality of hooks, each of said hooks being configured to engage the frame of the walker and the support body.

10. The support unit of claim 7 wherein the support body comprises a rigid body of material configured to define a cavity configuration to retrieve the portion of the user's leg.

11. The support unit of claim 10 wherein the attachment system comprises a rigid panel configured to engage the frame of the walker and the support body, whereby at least a portion of the rigid panel is attached to the support body.

12. A method for assisting movement of a handicapped user, comprising:
providing a walker;
attaching a support unit to the walker, said support unit comprising a support body which is configured to engage and retain a portion of the user's leg and an attachment system for affixing the support body to a frame of the walker; and
putting the portion of the user's lea in the support body so that a portion of the user's weight is supported by the frame of the walker.

13. The method of claim 12 wherein the support body comprises a flexible sheet of material.

14. The method of claim 12 wherein the attachment system comprises a plurality of hooks, each of said hooks being configured to engage the frame of the walker and the support body.

15. The method of claim 12 wherein the support body comprises a rigid body of material configured to define a cavity configuration to retrieve the portion of the user's leg.

16. The method of claim 15 wherein the attachment system comprises a rigid panel configured to engage the frame of the walker and the support body, whereby at least a portion of the rigid panel is attached to the support body.
